(19) United States
(12) Patent Application Publication
(10) Pub. No.: US 2010/0222241 A1
(43) Pub. Date: Sep. 2, 2010

(54) Clay Inhibitors for the Drilling Industry

(75) Inventors: Luigi Merli, Saronno va (IT); Guido De Stefano, Spring, TX (US); Giuseppe Li Bassi, Gavirate va (IT)

Correspondence Address: Mossman, Kumar & Tyler PC, P.O. Box 421239, Houston, TX, 77242, US

(73) Assignee: Lamberti SpA, Albizzate, VA (US)

(21) Appl. No.: 12/721,448

(22) Filed: Mar. 10, 2010

Related U.S. Application Data
(63) Continuation-in-part of application No. 11/573,185, filed on Feb. 2, 2007.

(30) Foreign Application Priority Data
Aug. 6, 2004 (IT) PCT/IT04/00454

(51) Int. Cl. C09K 8/18

(52) U.S. Cl. 507/129

(57) ABSTRACT

The inhibition of hydration of clays in drilling operations may be accomplished using an aqueous based drilling fluid containing from 0.2 to 5 wt % of 1,2-cyclohexanediamine and/or its salts.

### CROSS REFERENCE TO RELATED APPLICATION

This application is a Continuation-In-Part of U.S. patent application Ser. No. 11/573,185; which was filed on Feb. 2, 2007; claiming priority from PCT/IT2004/000454 which was filed on Aug. 6, 2004. Both of these references are fully incorporated herein by reference.

### BACKGROUND OF THE INVENTION

1. Field of the Invention

The present invention relates to clay hydration inhibitors for the drilling industry, that is to products which are effective for the inhibition of swelling of clay (also called shales) which comes into contact with the fluids used in the drilling and construction of oil and gas wells for the petroleum industry.

2. Background of the Art

The clay hydration inhibitors of the invention are 1,2-diaminocyclohexane and salts thereof. In rotary drilling of wells a drilling fluid circulates throughout the underground well to carry cuttings from the bit and to transport these cuttings to the surface. Contemporaneously, the drilling fluid cools and cleans the drill bit, as well as reduces friction between drill string and the drilled hole, and also stabilizes uncased sections of the well. Usually drilling fluids form a low permeability filter cake in order to seal any permeability associated with the surrounding geological formations.

Drilling fluids may be classified according to their fluid base: oil based fluids with solid particles suspended in an oil continuous phase and, possibly, water or brine may emulsified with the oil. Alternatively, water base fluids contain solid particles suspended in water or brine. Various solids may be added, deliberately or otherwise, to water based drilling fluids: a) organic colloids or clays used to impart viscosity and filtration properties; b) insoluble inorganic minerals to increase the fluid density; c) during the drilling operation formation solids may disperse into the drilling fluid.

Formation solids that become dispersed in a drilling fluid include cuttings from drilling and soil and solids from surrounding unstable formation. When the formation yields solids that are clay minerals which swell this can potentially compromise drilling time and increase costs.

Clays are typically composed of sheets that can have exposed surface hydroxyls. Multivalent atoms may create a negative potential at the clay surface and in this case, a cation can be adsorbed onto the surface. These cations may be exchangeable. Substitutions within the clay structure and the presence of exchangeable cations affect the tendency of the clay to swell in water. For example surface hydration gives swelling with water molecules adsorbed on clay surfaces. All types of clays can swell in this manner.

Another type of swelling is called osmotic swelling, when interlayer ion concentration leaches water between the clay unit layers, swelling the clay. Only some clays can undergo osmotic swelling. All types of clay swelling can cause a series of problems. This increases drag between the drill string and the sides of the borehole. This can cause loss of fluid circulation and sticking of the drill string and bit.

This is why development of effective clay swelling inhibitors is important to the oil and gas exploration industry. The present invention works towards a solution to these difficulties.

Many clay inhibitors are known including the use of inorganic salts such as potassium chloride which effectively inhibits clay swelling and which is well known to those skilled in the art. Numerous patents have been filed which describe techniques or products which can be used to inhibit clay swelling. Without completely summarizing the patent literature, and by way of example, we can cite the inhibitor compositions based on:

a) inorganic phosphates, described in U.S. Pat. No. 4,605,068 (YOUNG ET AL.);
b) polyalkoxy diamines and their salts, in U.S. Pat. No. 6,484,821, U.S. Pat. No. 6,609,578, U.S. Pat. No. 6,247,543 and US 20030106718, all by Patel at al.;
c) choline derivatives in U.S. Pat. No. 5,908,814 (PATEL ET AL.);
d) oligomethylene diamines and their salts, in U.S. Pat. No. 5,771,971 (HORTON ET AL.), and US 20020155956 (CHAMBERLAIN ET AL).

In particular U.S. Pat. No. 5,771,971 describes the use of diamines with a chain length of 8 or less, but does not mention the use of alicyclic diamines, such as 1,2-diaminocyclohexane. In U.S. Pat. No. 5,771,971 it is furthermore noticed that in the pH range of the specific application the clay inhibitors (amines or diamines) should be completely or almost completely protonated. 1,6-Hexamethylenediamine has a large percentage of the amine groups converted to the diammonium ion at a pH of 10 (85%), while 1,2-ethylendiamine only 0.31%.

In U.S. Pat. No. 5,771,971 it is postulated that the reason for this behavior is that the two amine units of 1,6-hexamethylenediamine are separated by six methylene groups, and that methylene groups have positive inductive effects; 1,6-hexamethylenediamine was therefore found to offer several advantages relative to currently used clay inhibitors.

### SUMMARY OF THE INVENTION

In one aspect, the invention is a method for inhibiting hydration of clays in drilling operations including the use of an aqueous based drilling fluid containing from about 0.2 to about 5 wt % of a hydration inhibitor selected from the group consisting of 1,2-cyclohexanediamine, 1,2-cyclohexanediamine salts, and mixtures thereof wherein the aqueous based drilling mud contains an aqueous based continuous phase.

In another aspect, the invention is an aqueous based drilling fluid containing from 0.2 to 5 wt % of a hydration inhibitor selected from the group consisting of 1,2-cyclohexanediamine, 1,2-cyclohexanediamine salts, and mixtures thereof, wherein the aqueous based drilling mud contains an aqueous based continuous phase.

In another aspect, the invention is a method for inhibiting hydration of clays in drilling operations including the use of an aqueous based drilling fluid containing a hydration inhibitor selected from the group consisting of 1,2-cyclohexanediamine, 1,2-cyclohexanediamine salts, and mixtures thereof, wherein the aqueous based drilling mud contains an aqueous based continuous phase.

In still another aspect, the invention is an aqueous based drilling fluid comprising a hydration inhibitor selected from the group consisting of 1,2-cyclohexanediamine, 1,2-cyclohexanediamine salts, and mixtures thereof, wherein the aqueous based drilling mud contains an aqueous based continuous phase.

### BRIEF DESCRIPTION OF THE DRAWINGS

The examples were carried on as described” above and are illustrated in the drawings. In the drawings the following abbreviations are used to indicate the clay inhibitor contained in the mud:

Base=blank, mud without clay inhibitor;

KCl=potassium chloride, from Aldrich Chemicals Co.;

DCH=purified 1,2-diaminocyclohexane (99 wt % from Dupont, US);

DCH 99=purified 1,2-diaminocyclohexane (99 wt % from Dupont, US);

DCH crude=technical grade 70 wt % 1,2-diaminocyclohexane;

DCH tail=technical grade 53 wt % 1,2-diaminocyclohexane.

FIG. 1 and FIG. 5 give Yield Point Values.

FIG. 2 and FIG. 6 give the Plastic Viscosity Data.

FIG. 3 gives the 10″ Gels Data.

FIG. 4 gives the 10′ Gels Data.

FIG. 7 gives the 600 rpm rheology data.

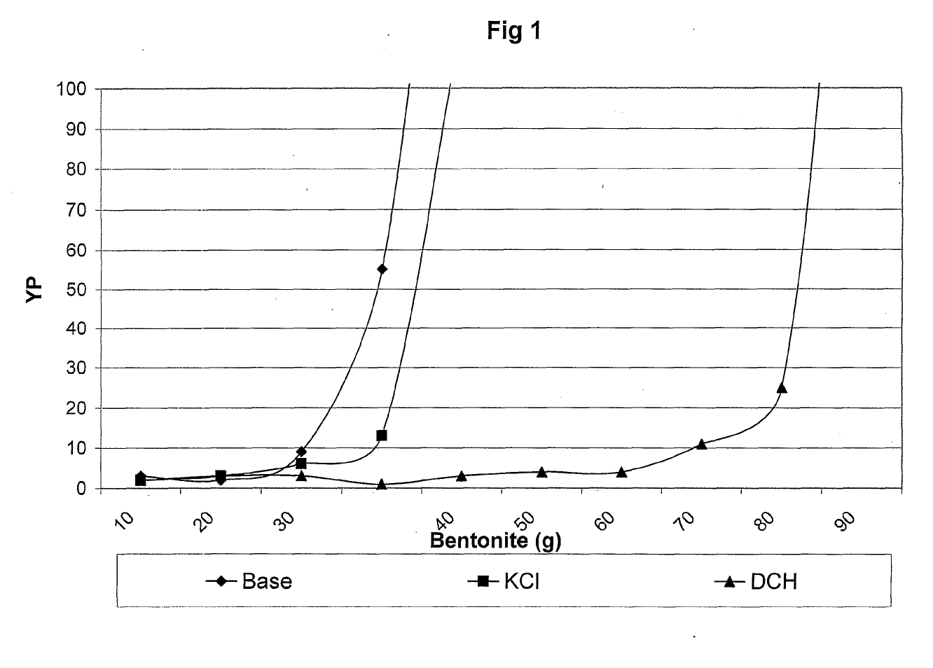

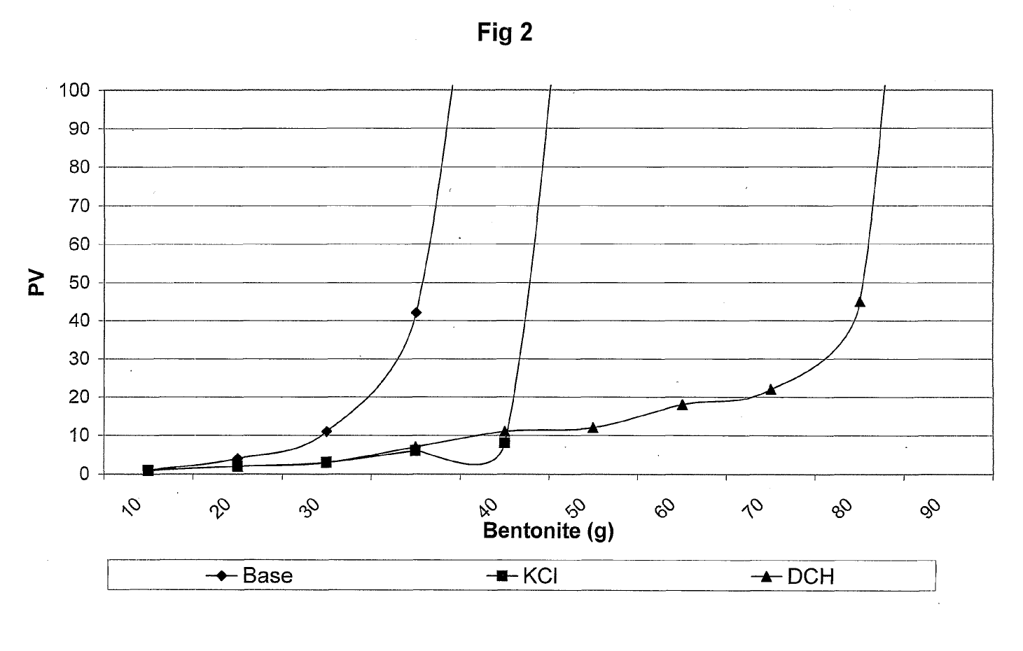

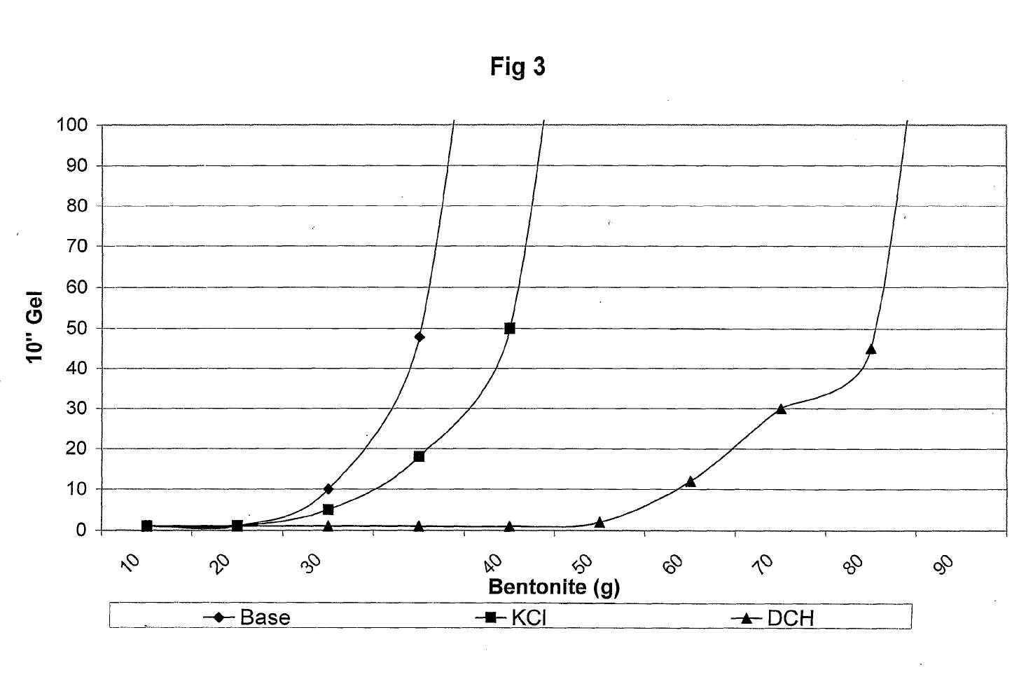

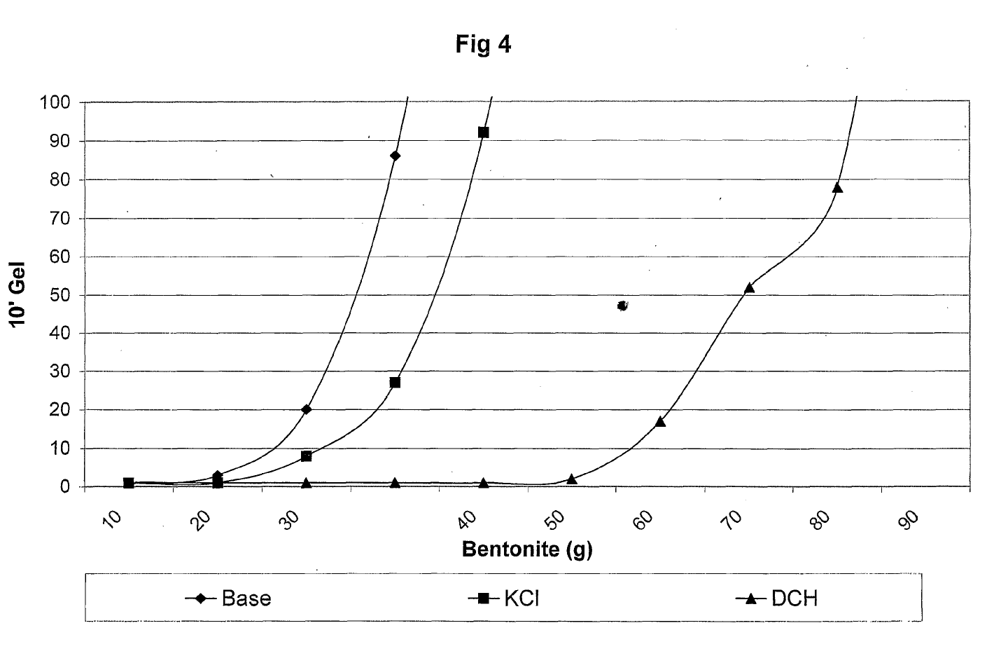

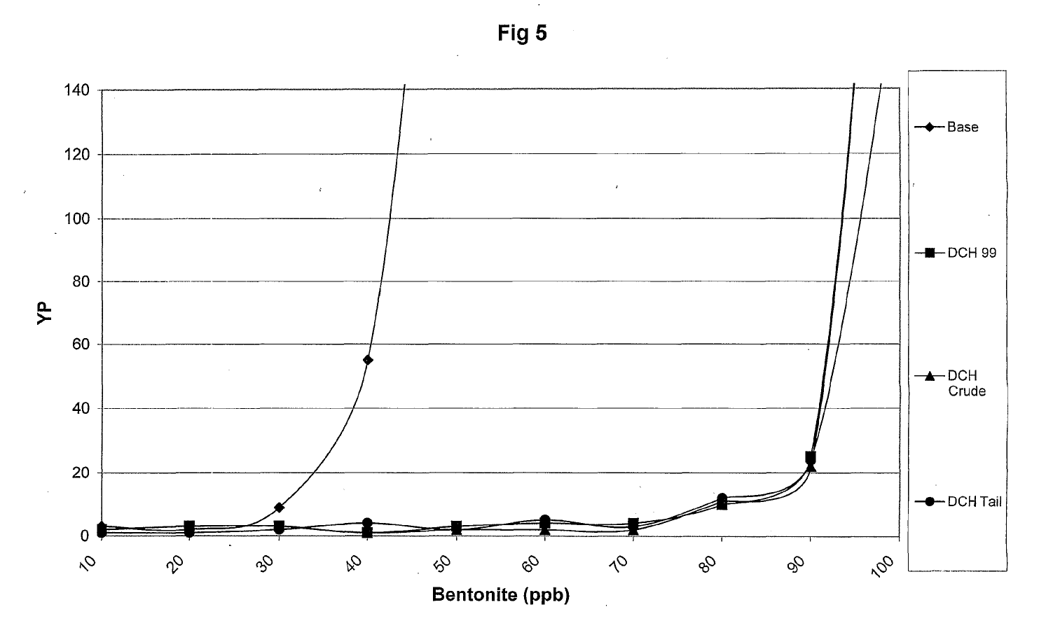

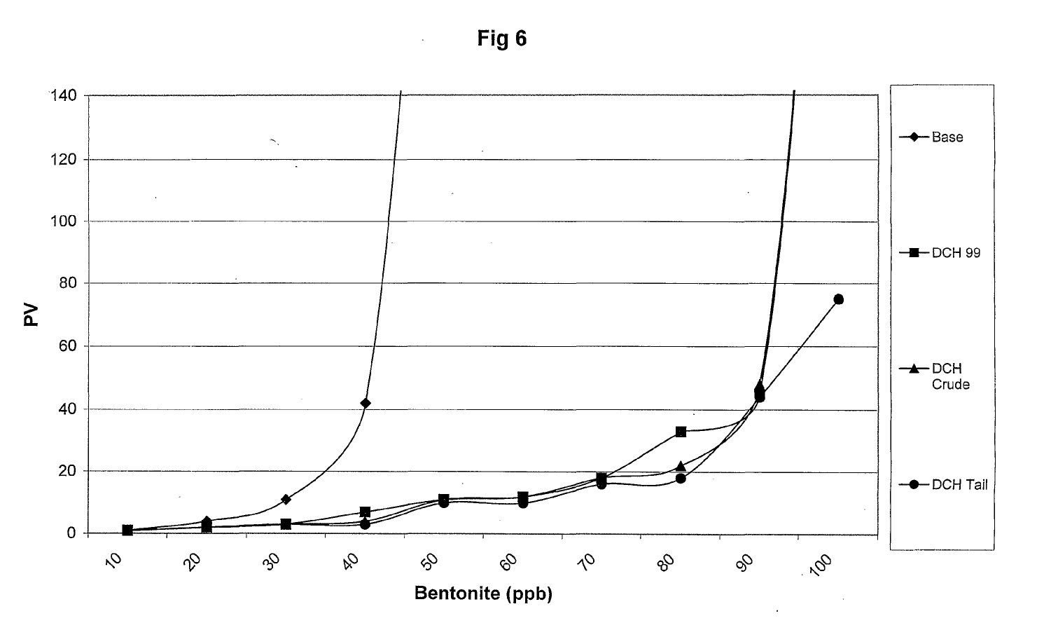

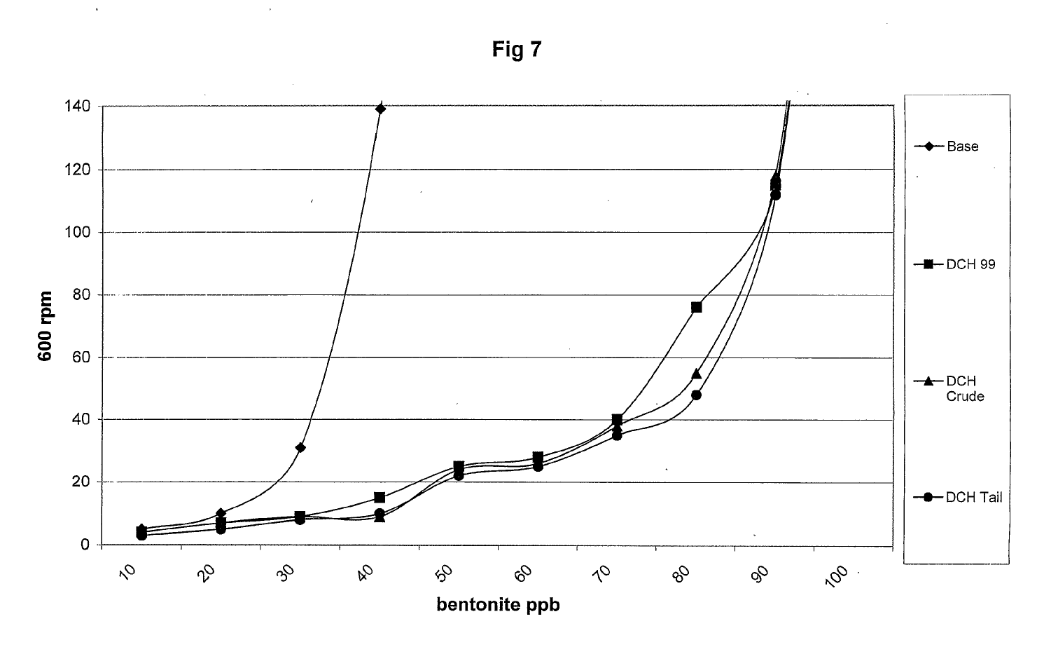

### DETAILED DESCRIPTION OF THE INVENTION

It has now been found that the alicyclic structure of 1,2-diaminocyclohexane and salts thereof positively affect the stabilizing effect on clay swelling. 1,2-diaminocyclohexane and its salts have revealed to be excellent clay hydration inhibitors for the petroleum industry, being able to effectively inhibit clay swelling in subterranean formations.

It is therefore a fundamental object of the present invention a method for inhibiting hydration of clays in drilling operations comprising the use of an aqueous based drilling fluid containing from 0.2 to 5 wt %, preferably from 2 to 4 wt %, of 1,2-cyclohexanediamine and/or its salts.

In yet another aspect the present invention is an aqueous based drilling fluid comprising from 0.2 to 5 wt %, preferably from 2 to 4 wt %, of 1,2-diaminocyclohexane and/or its salts. The salts of 1,2-diaminocyclohexane useful for the realization of the invention are of the inorganic or of the organic kind, the preferred salts being salts formed with HCl and monocarboxylic acids such as acetic acid. The application tests on the clay inhibitors of the invention and on prior art clay inhibitors were carried on by using purified 1,2-diaminocyclohexane (about 99 wt %), technical grade 70 wt % 1,2-diaminocyclohexane, and a 53 wt % technical grade 1,2-diaminocyclohexane.

Technical grade 1,2-diaminocyclohexane also contains 1,6-hexamethylenediamine, and in minor amounts, such compounds as, 2-methyl-1,5-pentamethylenediamine, hexamethyleneimine, 2-(aminomethyl)cyclopentylamine. Purified and technical grade 1,2-diaminocyclohexane are commercially available; both products, respectively containing from 90 to 99 wt % and from 40 to 89 wt % of 1,2-diaminocyclohexane, can be used as clay inhibitors according to this invention. 1,2-cyclohexanediamine and/or its salts are effective in any pH range and can be added to directly to the aqueous based drilling mud.

The aqueous based drilling mud contains an aqueous based continuous phase and the normally used additives, well known by the people skilled in the art, such as weight materials and viscosifying agents; the order in which the additives and the clay inhibitors of the invention are added into the mud is not critical. Useful weight materials may be selected from: barite, hematite, iron oxide, calcium carbonate, magnesium carbonate, magnesium organic and inorganic salts, calcium chloride, calcium bromide, magnesium chloride, zinc halides and combinations thereof.

The aqueous based continuous phase may be selected from: fresh water, sea water, brine, mixtures of water and water soluble organic compounds and mixtures thereof. The application tests were conducted to determine the ability of 1,2-diaminocyclohexane (and of its commercially available mixtures) to inhibit the swelling of a bentonite clay in an aqueous fluid, and to compare its bentonite swelling inhibition capability with that of potassium chloride, which is a well known clay inhibitor.

One advantage of the aqueous based drilling muds of the disclosure is that they may be prepared in a substantial absence of wetting agents such as those including a polyolefin amide alkene amine, and the like.

The method used in the application test is the following:

350 g of tap water and 10 g (10 ppb) of clay inhibitor are added to a clean glass jar; and

10 g (10 ppb) of bentonite are added and the mixture (mud) is shaken with an Hamilton Beach Shaker for 30 minutes.

All samples were adjusted to at pH of 12, except for the blank mud, whose pH was 8. The mixture is rolled at 150° F. for 16 hours, then its rheology is measured with a Fann 35A Viscometer. The procedure is carried out again, until the mud becomes too viscous to measure.

The results show that 1,2-diaminocyclohexane, even having different grade of purity, is an excellent clay hydration inhibition. While the compositions and methods of this invention have been described in terms of preferred embodiments, it will be apparent to those of skill in the art that variations may be applied to the process described herein without departing from the concept and scope of the invention. All such similar substitutes and modifications apparent to those skilled in the art are deemed to be within the scope and concept of the invention as it is set out in the following claims.

What is claimed is:

1. A method for inhibiting hydration of clays in drilling operations comprising the use of an aqueous based drilling fluid containing from about 0.2 to about 5 wt % of a hydration inhibitor selected from the group consisting of 1,2-cyclohexanediamine, 1,2-cyclohexanediamine salts, and mixtures thereof wherein the aqueous based drilling mud contains an aqueous based continuous phase.

2. The method of claim 1 wherein the hydration inhibitor is purified 1,2-diaminocyclohexane.

3. The method of claim 1 wherein the hydration inhibitor is technical grade 1,2-diaminocyclohexane.

4. The method of claim 1 wherein the hydration inhibitor is 1,2-cyclohexanediamine salts prepared using purified 1,2-diaminocyclohexane.

5. The method of claim 1 wherein the hydration inhibitor is 1,2-cyclohexanediamine salts prepared using technical grade 1,2-diaminocyclohexane.

6. The method of claim 1 wherein the hydration inhibitor is present at a concentration of from about 2 to about 4 weight percent.

7. The method of claim 6 wherein the hydration inhibitor is purified 1,2-diaminocyclohexane.

8. The method of claim 6 wherein the hydration inhibitor is technical grade 1,2-diaminocyclohexane.

9. The method of claim 6 wherein the hydration inhibitor is 1,2-cyclohexanediamine salts prepared using purified 1,2-diaminocyclohexane.

10. The method of claim 6 wherein the hydration inhibitor is 1,2-cyclohexanediamine salts prepared using technical grade 1,2-diaminocyclohexane.

11. The method of claim 1 wherein the aqueous based drilling fluid additionally comprises at least one material selected from the group consisting of weight materials, viscofying agents, and mixtures thereof.

12. The method of claim 1 wherein the weight materials are selected from the group consisting of: barite, hematite, iron oxide, calcium carbonate, magnesium carbonate, magnesium organic and inorganic salts, calcium chloride, calcium bromide, magnesium chloride, zinc halides and combinations thereof.

13. The method of claim 1 wherein the aqueous based drilling fluid includes an aqueous phase selected from fresh water, sea water, brine, mixtures of water and water soluble organic compounds, and mixtures thereof.

14. An aqueous based drilling fluid containing from 0.2 to 5 wt % of a hydration inhibitor selected from the group consisting of 1,2-cyclohexanediamine, 1,2-cyclohexanediamine salts, and mixtures thereof, wherein the aqueous based drilling mud contains an aqueous based continuous phase.

15. The aqueous based drilling fluid of claim 14 wherein the hydration inhibitor is purified 1,2-diaminocyclohexane.

16. The aqueous based drilling fluid of claim 14 wherein the hydration inhibitor is technical grade 1,2-diaminocyclohexane.

17. The aqueous based drilling fluid of claim 14 wherein the hydration inhibitor is 1,2-cyclohexanediamine salts prepared using purified 1,2-diaminocyclohexane.

18. The aqueous based drilling fluid of claim 14 wherein the hydration inhibitor is 1,2-cyclohexanediamine salts prepared using technical grade 1,2-diaminocyclohexane.

19. The aqueous based drilling fluid of claim 14 wherein the hydration inhibitor is present at from about 2 to about 4 weight percent.

20. The aqueous based drilling fluid of claim 14 additionally at least one material selected from the group consisting of weight materials, viscofying agents, and mixtures thereof.

21. The aqueous based drilling fluid of claim 20 wherein the weight materials are selected from the group consisting of: barite, hematite, iron oxide, calcium carbonate, magnesium carbonate, magnesium organic and inorganic salts, calcium chloride, calcium bromide, magnesium chloride, zinc halides and combinations thereof.

22. The aqueous based drilling fluid of claim 14 wherein the aqueous based drilling fluid includes an aqueous phase selected from fresh water, sea water, brine, mixtures of water and water soluble organic compounds, and mixtures thereof.

23. A method for inhibiting hydration of clays in drilling operations comprising the use of an aqueous based drilling fluid containing a hydration inhibitor selected from the group consisting of 1,2-cyclohexanediamine, 1,2-cyclohexanediamine salts, and mixtures thereof, wherein the aqueous based drilling mud contains an aqueous based continuous phase.

24. An aqueous based drilling fluid comprising a hydration inhibitor selected from the group consisting of 1,2-cyclohexanediamine, 1,2-cyclohexanediamine salts, and mixtures thereof, wherein the aqueous based drilling mud contains an aqueous based continuous phase.
